(19) United States
(12) Patent Application Publication
(10) Pub. No.: US 2016/0069261 A1
(43) Pub. Date: Mar. 10, 2016

(54) Ultra-High Efficiency Gas Turbine (UHEGT) with Stator Internal Combustion

(71) Applicant: -Ing. Meinhard Taher Schobeiri, College Station, TX (US)

(72) Inventor: -Ing. Meinhard Taher Schobeiri, College Station, TX (US)

(21) Appl. No.: 14/595,417

(22) Filed: Jan. 13, 2015

Related U.S. Application Data
(60) Provisional application No. 62/046,542, filed on Sep. 5, 2014.

(51) Int. Cl. F02C 3/14; F02C 7/264; F02C 7/22

(52) U.S. Cl. CPC F02C 3/14; F02C 7/222; F02C 7/264; F05D 2220/32; F05D 2240/10; F05D 2240/35

(57) ABSTRACT

Provided is an internal combustion system for an ultra-high efficiency gas turbine (UHEGT) engine which includes a fuel injection system, an ignition system, a stator system, and a rotor system. The stator system includes a plurality of stators positioned radially around a central axis. The fuel injection system injects fuel within the stator system and the ignition system is located within the stator system allowing combustion to take place therein. The rotor system includes a plurality of rotors positioned radially around the central axis downstream from the stator system. The UHEGT-technology completely eliminates the combustion chambers and replaces the latter with a distributed combustion system using stator-internal combustion technology. This technology allows for an increase in the thermal efficiency of gas turbines of at least about 7% (and in many cases much more) above the thermal efficiency of the most advanced existing gas turbines.

This application claims the benefit under 35 U.S.C. §119(e) of U.S. Provisional Application No. 62/046,542, filed on Sep. 5, 2014, which is hereby incorporated by reference in its entirety.

### I. BACKGROUND

A. Technical Field

The following disclosure generally relates to an ultra-high efficiency gas turbine engine which utilizes stator internal combustion.

B. Description of Related Art

The major parameter for increasing the thermal efficiency of power generation and aircraft gas turbines is the turbine inlet temperature. A comprehensive study conducted by the inventor showed the impact of a high turbine inlet temperature on engine performance and efficiency and its consequences on research and development investments. The study determined that the thermal efficiency of conventional gas turbine engines can be substantially increased without a significant increase in turbine inlet temperature by changing the technology. The suggested technology change was based on classical method for thermal efficiency augmentation by adding heat at higher temperature. This principal was applied for the first time to design a Compressed Air Energy Storage (CAES) having two combustion chambers and two multi-stage turbines. A detailed dynamic performance and efficiency study of this CAES-gas turbine compared to a gas turbine having only one combustion chamber and one re-designed multi-stage turbine gave a substantial increase in thermal efficiency in the order of 5%-7%. Although this standard efficiency improvement method was routinely used in Compressed Air Energy Storage facilities, it did not find its way into the power generation and aircraft gas turbine design until the late eighties. One reason for not applying this very effective method to gas turbines was the inherent problem of integrating typically large volume combustion chambers into a compact gas turbine engine. Adding a second conventional large volume combustion chamber such as those in CAES facilities raised a number of unforeseeable design integrity and operational reliability concerns that deterred turbine engine manufacturers. In an intensive effort, a new combustion technology was developed and integrated into a new gas turbine engine known as the GT-24/26. The GT-24/26 included one reheat stage turbine followed by a second combustion and a multistage turbine. The addition of the reheat turbine stage and the second combustion chamber required a significant increase of the compressor pressure ratio above that which was optimized for conventional baseline gas turbine engines.

Further increases in the thermal efficiency of gas turbines are highly desirable. Accordingly, the inventor had contemplated the concept of a gas turbine which incorporates the use of stator-internal combustion and eliminates the combustion chamber. An explanation of this broad concept as well as the general workings and evolution of gas turbine technology is described in “Meinhard, Schobeiri, 2005 “Turbomachinery Flow Physics and Dynamic Performance”, Springer-Verlag, New York, Berlin, Heidelberg, ISBN 3-540-22368-1, which is hereby incorporated by reference in its entirety. However, while the broad idea of an Ultra-High Efficiency Gas Turbine has been previously considered by the inventor, a manner of accomplishing it had yet to be developed until the present disclosure. Accordingly, the disclosure provided below provides for a gas turbine engine having a thermal efficiency which far exceeds that of the GT 24/26.

### II. SUMMARY

Provided is a stator-internal combustion system for an ultra-high efficiency gas turbine engine having a fuel injection system, an ignition system, a stator system, and a rotor system. The stator system includes a plurality of stators positioned radially around a central axis and the stator system has a leading edge and a trailing edge. The fuel injection system injects fuel within the stator system through at least one of the following mechanisms: a) a plurality of conduits which inject fuel at the leading edge of the stator system and b) a plurality of conduits which inject fuel within the stators themselves. The ignition system is located within the stator system. The rotor system comprises a plurality of rotors positioned radially around the central axis downstream from the stator system. The stator-internal combustion system does not require the use of a gas turbine combustor.

According to other aspects of the present disclosure, the plurality of stators are positioned radially around a substantially cylindrical turbine hub and a turbine shroud encircles the plurality of stators which extend from the turbine hub. The turbine shroud has an inner circumference and the turbine hub has an outer circumference.

According to further aspects of the present disclosure, the fuel injection system injects fuel within the stator system through a plurality of conduits which inject fuel at the leading edge of the stator system and the fuel injection system includes a plurality of conduits which radially extend from the inner circumference of the turbine shroud to the outer circumference of the turbine hub.

According to further aspects of the present disclosure, the plurality of conduits include a plurality of cylindrical tubes having a first end opening and a second end. The first end opening functions as an inlet and receives fuel from at least one main fuel line which encircles the turbine hub and the second end is attached at various positions along the circumference of the turbine hub.

According to further aspects of the present disclosure, the plurality of cylindrical tubes include a first fuel ejection surface and a second fuel ejection surface opposite the first fuel ejection surface. The first fuel ejection surface and the second fuel ejection surface comprise a plurality of fuel injection holes allowing fuel to enter into a combustion zone within the stator system which is located upstream from the plurality of radially positioned stators.

According to further aspects of the present disclosure, the position of the fuel injection holes and their angles along the first fuel ejection surface and the second fuel ejection surface are varied and wherein the fuel injection holes have radii which are varied. The varied position and radii of the fuel injection holes as well as the fuel ejection angles from the holes allow a prescribed temperature profile from the turbine hub to the tip of the stator blades.

According to further aspects of the present disclosure, combustion within the stator system results in the plurality of stators having an exit temperature non-uniformity value of about 5.2%. Compared to conventional gas turbine combustors which have a temperature non-uniformity of 22.5%, the UHEGT offers an improvement of over 17%.

According to further aspects of the present disclosure, combustion within the stator system results in the rotor system having a fully uniform exit temperature.

According to a further aspect of the present disclosure, the fuel injection system injects fuel within the stator system through a plurality of conduits which inject fuel within the stators themselves and wherein the plurality of stators comprise a hollow body defining an open leading edge, an open trailing edge and a pressure surface and a suction surface extending between said leading and trailing edges.

According to further aspects of the present disclosure, the open leading edge of the plurality of stators allows compressed air to enter into an interior portion of each stator blade and the open trailing edge allows high pressure air to exit from the interior portion of each stator blade.

According to further aspects of the present disclosure, each stator blade comprises at least one fuel injection hole allowing fuel to enter within the interior portion of each stator blade.

According to further aspects of the present disclosure, fuel enters the fuel injection holes within the plurality of stators through a plurality of fuel injectors comprising a plurality of cylindrical tubes having a first end opening and a second end. The first end opening functions as an inlet and receives fuel from at least one main fuel line which encircles the turbine hub and the second end is attached to the fuel injector holes on the plurality of stators.

According to further aspects of the present disclosure, the ignition system is positioned within the interior of the stator blades allowing combustion to occur within the hollow interior of the plurality of the stators.

According to further aspects of the present disclosure, the leading edge of the plurality of stator blades are expanded to allow for the generation of two pre-defined vortex systems.

According to further aspects of the present disclosure, the hollow stator blades have a suction and a pressure side within the interior of the stator blades and wherein the suction and pressure sides within the interior of the stator blades have slots which are optimized to ensure that the stator blades are not subjected to excessive thermal stresses.

According to further aspects of the present disclosure, each stator blade comprises a first fuel injector hole and a second fuel injector hole. The second fuel injector hole is positioned downstream from the first fuel injector hole on the stator blade. The second fuel injector hole is offset at a lower position from the first fuel injector hole on the stator blade. A first fuel injector extends from the main fuel line to the first fuel injector hole and a second fuel injector extends from the main fuel line to the second fuel injector hole. The positioning of the first and second fuel injector holes allow for a substantially uniform temperature distribution resulting from combustion which takes place within each stator blade. In certain embodiments, the first and second fuel injectors may be in the shape of a conduit such as a tube.

According to a further aspect of the present disclosure, the fuel injection system injects fuel within the stator system through a plurality of conduits which inject fuel at the leading edge of the stator system and a plurality of axial swirlers are positioned radially around the substantially cylindrical hub upstream from the plurality of stators within the stator system. The turbine shroud encircles the plurality of axial swirlers and the plurality of axial swirlers comprise at least one inner hub, an outer hub and vanes positioned between the inner and outer hub.

According to further aspects of the present disclosure, the vanes have an inlet angle of 90 degrees and an exit angle of 45 degrees.

According to further aspects of the present disclosure, the fuel injection system comprises a plurality of cylindrical tubes having a first end opening and a second end opening. The first end opening functions as an inlet and receives fuel from at least one main fuel line which encircles the turbine hub and the second end opening is attached to the inner hub of the plurality of axial swirlers to allow fuel to be injected for combustion within the stator system.

Also provided is a method for operating an ultra-high efficiency gas turbine engine. The method includes the following steps: supplying fuel from a main fuel line which encircles a substantially cylindrical turbine hub to a plurality of cylindrical tubes which radially extend from the main fuel line to a substantially cylindrical turbine hub upstream from a plurality of stators radially extending from the turbine hub within a stator system; injecting fuel from the plurality of cylindrical tubes from a plurality of fuel injection holes positioned along the cylindrical tubes into a combustion zone within the stator system; allowing compressed air generated by a compressor upstream from the stator system to enter the stator system to create an air/fuel mixture within the stator system; igniting the air/fuel mixture at start-up through an ignition system positioned within the stator system; generating a high pressure combustion gas flow through combustion of the air/fuel mixture within the stator system which passes through the plurality of stators within the stator system towards a plurality of rotors positioned downstream from the plurality of stators, wherein the plurality of rotors radially extend from the turbine hub; allowing the high pressure combustion gas flow to rotate the plurality of rotors about a central axis within the turbine to generate power. The method also provides that combustion within the stator system results in the plurality of stators having an exit temperature non-uniformity value of about 5.2%.

### III. BRIEF DESCRIPTION OF THE DRAWINGS

The disclosed “Ultra-High Efficiency Gas Turbine Engine” as set forth herein and corresponding methods and systems may take physical form in certain parts and arrangement of parts, embodiments of which will be described in detail in this specification and illustrated in the accompanying drawings which form a part hereof and wherein:

FIG. 1 illustrates several temperature-entropy diagrams of conventional gas turbines compared to an ultra-high efficiency gas turbine engine.

FIG. 2 illustrates curve charts for thermal efficiency and specific work comparison of conventional gas turbines compared to various ultra-high efficiency gas turbine engines.

FIGS. 3a-3d illustrate mechanical diagrams and corresponding temperature-entropy diagrams for conventional gas turbines compared to various ultra-high efficiency gas turbine engines.

FIG. 4 illustrates a mechanical diagram of a conventional gas turbine combustion chamber.

FIG. 5 illustrates an exemplary arrangement of several combustors on a conventional gas turbine engine.

FIGS. 6a and 6b illustrate an exemplary fuel injector configuration for an exemplary ultra-high efficiency gas turbine engine.

FIG. 7 is a diagram illustrating the arrangement of fuel injectors upstream of the stator row in an exemplary ultra-high efficiency gas turbine engine.

FIG. 8 is an image illustrating the generation of vortex systems by the design of the fuel injector tubes of FIGS. 6a and 6b and their effect on fuel particles within the combustion volume.

FIG. 9 is a temperature distribution image illustrating a fully uniform rotor exit temperature for an exemplary ultra-high efficiency gas turbine engine.

FIG. 10 is a temperature distribution image showing temperature distribution before the fuel injectors, inside the stator and downstream of the stator and rotor in an exemplary ultra-high efficiency gas turbine engine.

FIG. 11 includes a temperature distribution image showing temperature distribution before the fuel injectors, inside the stator and downstream of the stator and rotor in a conventional gas turbine engine.

FIG. 12 is a perspective view of an exemplary embodiment of the ultra-high efficiency gas turbine engine.

FIG. 13 is a perspective, cut-out view of an exemplary embodiment of a single-stage turbine as an element of a multi-stage ultra-high efficiency gas turbine engine.

FIG. 14 is a diagram illustrating fuel injectors placed inside the stator blades in an exemplary embodiment of the ultra-high efficiency gas turbine engine.

FIG. 15 is a temperature distribution image illustrating the temperature distribution within stator blades in an exemplary embodiment of the ultra-high efficiency gas turbine engine wherein the fuel injectors are placed inside the stator blades.

FIG. 16 is an image illustrating the velocity vectors of fuel injectors placed within stator blades within an exemplary embodiment of the ultra-high efficiency gas turbine engine.

FIG. 17 is a temperature distribution image of fuel as it is ejected from the fuel injectors.

FIG. 18 is a temperature distribution image inside and outside of the stator blades in an exemplary embodiment of the ultra-high efficiency gas turbine engine.

FIG. 19 includes perspective views of several axial swirlers utilized in an exemplary embodiment of the ultra-high efficiency gas turbine engine.

FIG. 20 is a diagram illustrating the arrangement of an axial swirler and fuel injector upstream of the stator row in an exemplary ultra-high efficiency gas turbine engine.

FIG. 21 is a temperature distribution diagram and image illustrating temperature distribution before and after the stator and rotor.

FIG. 22 is a temperature distribution image before and after the stator and rotor in an exemplary embodiment of the ultra-high efficiency gas turbine engine.

FIG. 23 is a cut out perspective view of an exemplary embodiment of the ultra-high efficiency gas turbine engine.

### IV. DETAILED DESCRIPTION

While nowadays the public attention is focused on alternative energy production, the fact that the possibility exists for tremendous efficiency gains associated with substantial fuel and CO₂ reduction by introducing a new generation of gas turbine engines is entirely overlooked. Given the fact that conventional gas turbine technology, with the exception of one case, has not changed in the past 50 years and the reluctance of most of the gas turbine manufacturers to make a technology change, the time has come to introduce a completely new technology that substantially increases the gas turbine thermal efficiency and substantially reduces fuel consumption and CO₂ emissions. Keeping the conventional turbine engine design, an enhancement of thermal efficiency can only be achieved by substantially increasing the turbine inlet temperature. This method of increasing thermal efficiency within gas turbine engines, however, has its limitations. Among several issues that pertain to solid mechanics, including heat transfer and material problems associated with a higher turbine inlet temperature, two are specially worth distinguishing: (1) the massive cooling of the turbine front stages through the extraction of a substantial portion of air from the compressor and (2) protecting the blade material either by applying a thermal barrier coating or using a ceramic material. In any event, higher thermal stresses associated with an increased turbine inlet temperature associated with higher NO_{X} production will persist. It is also well known that improving the compressor and turbine efficiency above the current advanced level brings only a marginal increase in thermal efficiency.

Considering the above, to substantially increase the thermal efficiency without a significant increase in the turbine inlet temperature requires a change of technology. This issue has been the driving force behind the effort to develop new technological concepts that radically change the thermal efficiency levels of the next generation of gas turbines. One concept outlined in this disclosure deals with an Ultra-High Efficiency Gas Turbine Engine (UHEGT) with stator internal combustion. This means that the combustion process is no longer contained in isolation between the compressor and turbine. Rather, the combustion process is distributed within the turbine stator rows or stator system. Thus, the UHEGT allows for total elimination of the combustion chamber, as we have known it since the invention of the first gas turbine engine. As set forth below, the proposed distributed combustion results in high thermal efficiencies which cannot be achieved by conventional gas turbine engines. The results of a detailed study show that the disclosed UHEGT drastically improves the thermal efficiency of gas turbines in the range from about 7 to about 10% above the current highest efficiency engines. Detailed calculation shows that the application of UHEGT technology to aircraft engines reduces the fuel consumption by 50% and increases the bypass ratio to 14.5%, which is 20% above the bypass ratio of the advanced Pratt and Whitney 1000G high bypass geared turbofan engine.

The Ultra High Efficiency Gas Turbine (UHEGT) disclosed herein deals with the development of a new gas turbine engine, where the combustion process takes place within the turbine stator rows or stator system, leading to a distributed combustion. Thus, the UHEGT allows for eliminating the combustion chamber within the gas turbine.

The disclosed technology may be applied to gas turbine engines ranging from about 100 kW to about 400 MW and above. It is equally applicable to power generation engines (e.g., electric power) and aircraft engines. It has been shown in a detailed study set forth in Schobeiri, M. T., 2012, “Turbomachinery Flow Physics and Dynamic Performance,” Second and Enhanced Edition, Springer-Verlag, New York, Berlin, Heidelberg, that the concept of a UHEGT can drastically improve the thermal efficiency of gas turbines from 5% to 7% above the current highest efficiency set by GT24/26 (ABB Ltd., Zurich, Switzerland) which has a thermal efficiency of about 40.5% at full load. Applied to turbofan engines, the technology will substantially reduce fuel consumption by about 50%.

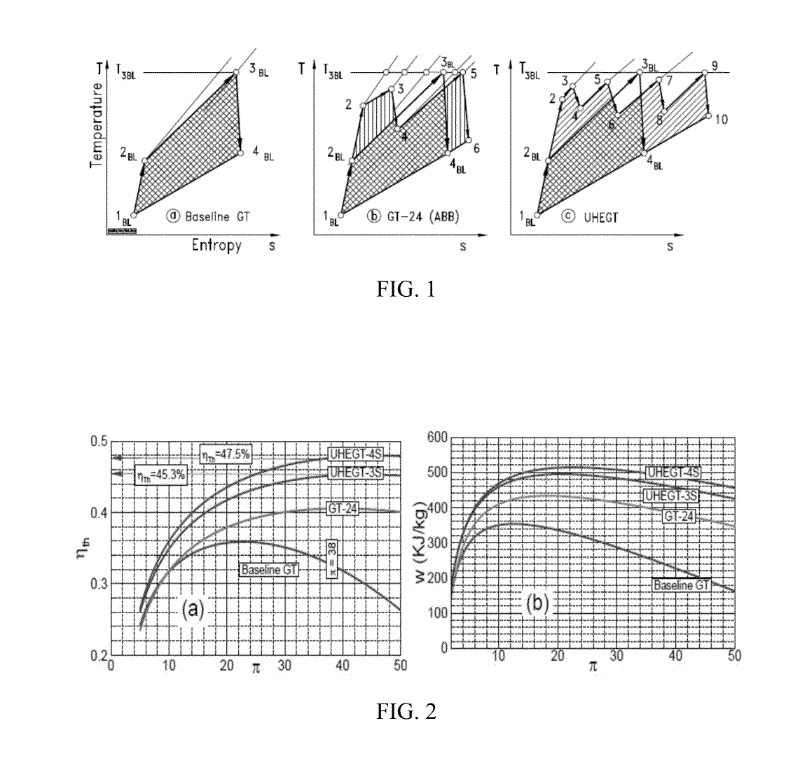

To demonstrate the thermal efficiency and other claims of the conceptualized UHEGT, a study was conducted comparing three conceptually different power generation gas turbine engines: a conventional gas turbine having single shaft and a single combustion chamber, a gas turbine (GT-24) with sequential combustion (i.e., having a multi-stage compressor, a first combustion chamber, a reheat turbine stage, a second combustion chamber and a multi-stage turbine), and an UHEGT with stator internal combustion. The evolution of the gas turbine process that represents the thermal efficiency improvement over these three gas turbine engines is shown in FIG. 1. In particular, FIG. 1 illustrates three temperature-entropy diagrams comparing a baseline gas turbine, the GT-24 and an ultra-high efficiency gas turbine (UHEGT) which may have up to four stages with four integrated stator internal combustion chambers. The temperature-entropy diagrams within FIG. 1 show the thermodynamic behavior of a gas turbine engine, details of which are explained in Schobeiri, M. T., 2012, “Turbomachinery Flow Physics and Dynamic Performance,” Second and Enhanced Edition, Springer-Verlag, New York, Berlin, Heidelberg. In short, the difference between the specific turbine shaft power (for base line is represented by the temperature difference T3−T4) and the compressor specific shaft power (for base line is represented by the temperature difference T2−T1). The larger this difference is, the better is the thermal efficiency and the net power. As seen in FIG. 1(b), this is the case for GT-24 which has two combustion chambers followed by a multistage power turbine. To go beyond the GT-24 efficiency of 40.5%, a technology change is required. As shown in FIG. 1(c), the newly developed UHEGT substantially increases the gas turbine thermal efficiency. Increased turbine power is represented by the sum of (T3−T4)+(T5−T6)+(T3−T4)+(T5−T6)+(T7−T8)+(T9−T10) minus the compressor power represented by the compressor temperature differences (T2−T1).

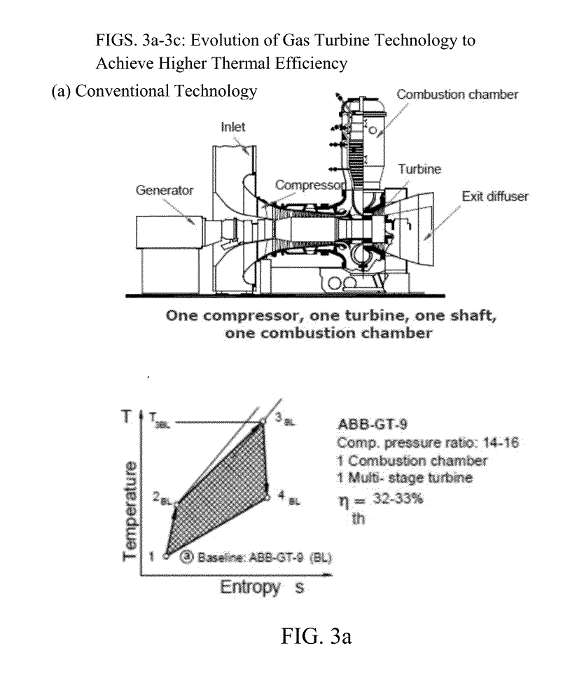

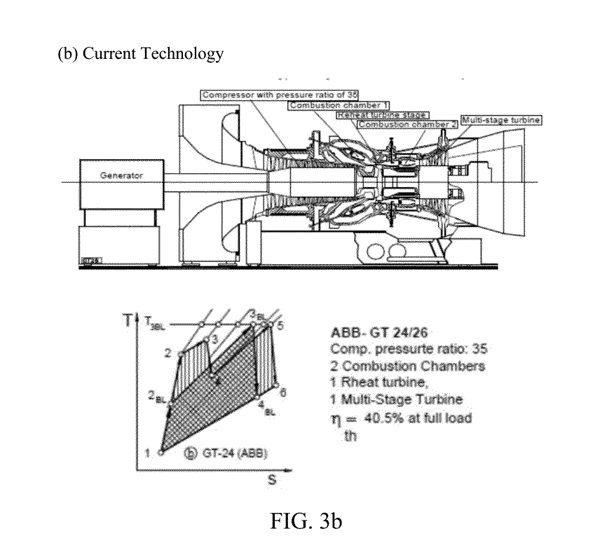

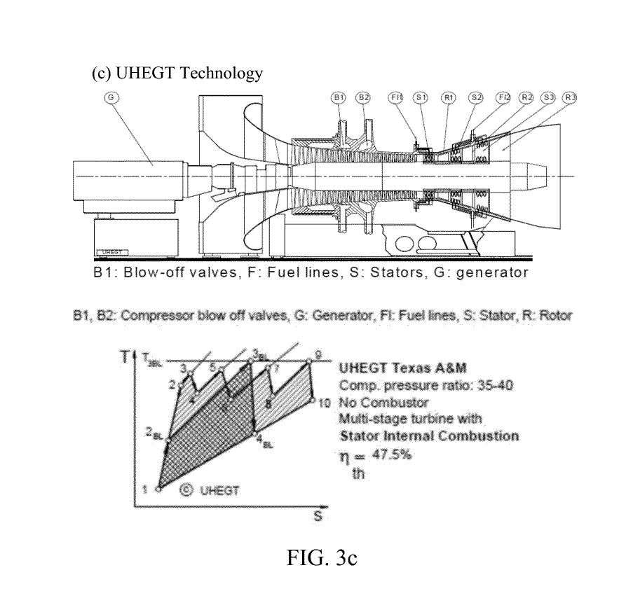

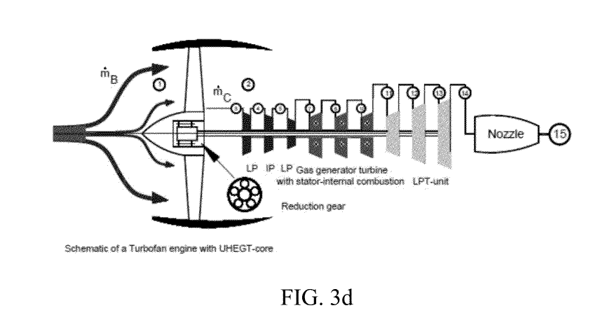

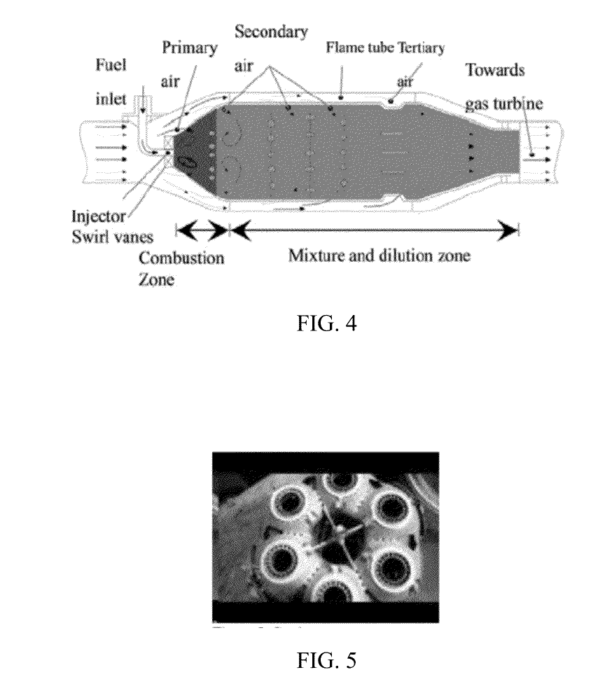

As described in Schobeiri, M. T., 2012, “Turbomachinery Flow Physics and Dynamic Performance,” Second and Enhanced addition, Springer-Verlag, New York, Berlin, Heidelberg, using a consolidated turbine inlet temperature T_{3BL} for a baseline gas turbine engine, (see FIG. 3), thermal efficiency is achieved by optimizing the compressor pressure ratio πₒₚₜ=(p₂/p₁)ₒₚₜ and using the existing compressor and turbine stage polytropic efficiencies η_{c}, η_{T}. As shown in FIG. 3a, a major source of total pressure loss occurs within the combustion chamber and in some cases may range from about 3.5% to about 5.5%. The total pressure losses of the inlet and exit, as well as the bearing friction, though integrated in the calculation, play a secondary role in most cases. Based on the turbine inlet temperature, today's stand-alone baseline thermal efficiency ranges from η_{BL}=about 34 to about 39%. Improving the compressor and turbine efficiency above the current advanced level brings only a marginal efficiency increase. Substantial efficiency improvement was achieved by introducing a single stage reheat principal as shown in FIG. 3b. The vertically hatched area translates into the efficiency improvement, which in case of the ABB-GT-24 (see FIG. 4), resulted in efficiency improvement of about 6% above the baseline efficiency η_{TGT24}=η_{TBL+}5-6%. A detailed dynamic engine simulation of the ABB GT-24 gas turbine engine verified a thermal efficiency of η_{Th}=about 40.5%, which corresponds to the measured efficiency of about 40%. This tremendous efficiency improvement was achieved despite the fact that (a) the compressor pressure ratio is far greater than the optimal conventional one (π_{GT-24}≈2×π_{Opt BL}) and (b) the introduction of a second combustion chamber inherently causes additional total pressure losses.

A further significant efficiency improvement is achieved by eliminating the combustion chambers altogether and placing the combustion process inside the stator and rotor blade passages. FIG. 3c schematically reveals the thermodynamic process of this gas turbine engine, where combustion is placed inside the stator flow passage of a multi-stage turbine. Starting from the compressor exit pressure, point 2, fuel is added inside the stator flow passage raising the total temperature, point 3. The expansion in the stator is followed by the expansion through the first turbine rotor flow passage, point 4. The same alternatively diabatic-adiabatic expansion process is repeated in the following turbine stator and rotor blade passages (points 5 through 9). The cross-hatched area refers to the baseline process, whereas the simple-hatched area represents the thermal efficiency gain. A detailed calculation revealed that for an UHEGT with three stator combustion chambers, a thermal efficiency above 45% is calculated. This exhibits an increase of at least 5% above the most advanced gas turbine engine GT-24, which is close to 40%. Increasing the number of stator internal combustion chambers to 4, raises the efficiency level to above 47%. A detailed quantitative calculation of each process sketched in FIG. 1 is presented in FIG. 2. FIGS. 2a and 2b compares the thermal efficiency and specific work of a baseline gas turbine, the GT-24 and a UHEGT with three and four stator-internal combustion chambers (UHEGT-3S and UHEGT-4S), respectively. As shown for UHEGT-3S, a thermal efficiency above 45.30% is calculated. This exhibits an increase of at least 5.5% above the efficiency of the most efficient gas turbine engine, the GT-24/26, which is above to 40% as FIG. 2 shows. Increasing the number of stator internal combustion chambers to 4 (see the curve labeled UHEGT-4S), raises the efficiency to above 47.5%. This is an enormous efficiency increase compared to any existing gas turbine engine. FIG. 2a compares the thermal efficiency of a conventional gas turbine with the GT24/26 and a UHEGT having three and four rows of stator internal combustion chambers (3S and 4S).

FIG. 2b reveals the specific work comparison for the gas turbines discussed above. Compared to the GT-24, the UHEGT has about 20% higher specific work, making this technology very suitable for aircraft engines, stand-alone engines as well as for combined cycle power generation applications. This efficiency increase can be established at a compressor pressure ratio of π_{UHEGT}≈35-40, which can be achieved easily by existing compressor design technology with a conventional polytropic efficiency of about 87%. In performing the preprocessor calculation, compressor and turbine efficiencies are calculated on a row by-row basis. This automatically accounts for an increase of secondary flow losses based on aspect ratio decrease. Thus, with respect to the compressor, the efficiency decrease with increasing the pressure ratio is inherently accounted for. FIGS. 3a, 3b and 3c show the evolution of efficiency associated with the change of technology. Starting with the conventional gas turbine design having one compressor, one combustion chamber and one multistage turbine, FIG. 3(a), the temperature-entropy diagram shows the thermodynamic process of this basic configuration. The first change of technology realized by designing the gas turbine GT24/26 is shown in FIG. 3(b). The additional area in the temperature-entropy diagram (vertically hatched) is responsible for the efficiency improvement shown in FIG. 2. A schematic of an UHEGT engine with a multi-stage compressor and the internal combustion within the first, second, third and fourth stator internal combustion chambers is shown in FIG. 3(c). Further enhancement of the area in temperature-entropy diagram (red hatched) marks the additional efficiency increase shown in FIG. 2. This configuration allows any unburned fuel particles to further burn within the subsequent rotor passages resulting in further mixing of the air/fuel mixture and achieving a more complete combustion of the air/fuel mixture.

In certain embodiments, UHEGT Technology may be applied to the core of an advanced turbofan engine as shown within FIG. 3d. The results show that a core with an UHEGT outperforms the GP7000 turbofan jet engine (Engine Alliance, East Hartford, Conn.) by a reduction in specific fuel consumption of over 50%.

Factors which enable the UHEGT engine disclosed herein to achieve optimized efficiency and reductions in fuel consumption include the integrated three or more stator internal combustion stages within three turbine stator blade rows as well as the higher bypass ratio obtained with a higher overall pressure ratio.

Understanding the physics underlying the stator internal combustion requires understanding the working principle of a conventional gas turbine combustion chamber. FIG. 4 shows the schematic of such a combustion chamber. As illustrated within FIG. 4, the length of the mixing zone in a conventional gas turbine is much larger than the length of the combustion zone.

Air from the compressor enters the combustion chamber with a velocity larger than the compressor exit velocity. The higher velocity is due to the cross section blockage caused by the presence of the combustors. This cross section blockage is shown within FIG. 5. A major portion of the compressor air, called the primary air, enters the injector swirl vanes and flows into a relatively small combustion zone with a diffuser section. Air exiting from the swirler produces a large vortex that ensures a strong mixture of fuel particles with the air. Going through the mixing zone, secondary air is added and mixed with the combustion gas to accomplish a stable combustion.

A number of deficiencies are associated with conventional combustors. Those deficiencies include a strong temperature non-uniformity including the area above the exit of the combustor. This temperature non-uniformity causes non-uniform stress distribution in the rotor blades located downstream from the stators, leading to cracks in the turbine blades. In certain cases, temperature non-uniformity may be up to about 22%. Another deficiency associated with the use of conventional combustors includes the generation of large vortices. This often leads to strong non-uniform turbulence intensity distribution and non-uniform mixing of fuel and air. This deficiency accounts for the reason why a large mixture zone is needed for conventional turbines (See FIG. 5). A further deficiency is the need for a large combustor length and volume to occupy the air/fuel mixture zone. These deficiencies are completely removed through the use of the disclosed UHEGT engine technology

The disclosed UHEGT technology may be characterized by the combination of a fuel injector-stator unit (SIU) with the subsequent downstream rotor row. Extensive computer simulations of aero-thermo, combustion dynamics were conducted to determine (a) the optimum configuration of SIU and (b) its combination with the downstream rotor row.

The criteria for achieving an optimum designed fuel injector-stator unit or stator system include: uniform concentration and distribution of the air/fuel mixture; flame stability; acceptable uniform temperature distribution downstream of the fuel injectors; uniform temperature distribution downstream of the stators or stator system; acceptable temperature level at the turbine hub and tip downstream of the fuel injectors; acceptable total pressure loss for the investigated fuel injector-stator unit or stator system; and substantially uniform temperature distribution downstream of the rotor.

Several embodiments have been designed and simulated numerically to achieve the optimum performance for the UHEGT. All of these embodiments, any related embodiments and derivatives of these embodiments are to be construed as subject matter related to the present disclosure. All UHEGT embodiments combine the combustion process with the fuel injector-stator unit or stator system so that the combustion process occurs within the fuel injector-stator unit or stator system. The UHEGT is capable of operating at a consolidated turbine inlet temperature used in current conventional gas turbine design without excessive blade cooling. Turbine inlet temperature above the current one will further increase the UHEGT thermal efficiency and may be achieved by using a thermal barrier coating (TBC) or ceramic material on the stator blades. The stator blades of the fuel injector-stator units or stator system are manufactured from any material having the strength and heat resistance necessary for withstanding the internal combustion temperatures of the gas turbine. In certain embodiments, the stator blades and other components may be manufactured from silicon carbide. In further embodiments, the stator blades and other components may be manufactured from silicon carbide which has been gel cast and sintered into the desired shape. A process for sintering silicon carbide parts is disclosed in U.S. patent application Ser. No. 14/321,215 filed on Jul. 1, 2014 and is herein incorporated by reference in its entirety.

Accordingly, a stator-internal combustion system for an ultra-high efficiency gas turbine engine (UHEGT) is provided. The stator-internal combustion system includes a fuel injection system, an ignition system, a stator system, and a rotor system. The stator system includes a plurality of stators positioned radially around a central axis. The fuel injection system is designed to inject fuel within the stator system and the ignition system is located within the stator system to initiate the combustion process within the stator system. The rotor system includes a plurality of rotors positioned radially around the central axis downstream from the stator system. The rotor system may also include a plurality of rotor rows, each of which have a certain number of blades that are optimized aerodynamically and positioned radially around the central axis downstream from the stator system. The stator-internal combustion system of the UHEGT does not include a gas turbine combustor. The plurality of stators are positioned radially around a substantially cylindrical turbine shroud. A turbine hub encircles the plurality of stators which extend from the turbine shroud. The turbine shroud has an inner circumference and the turbine hub has an outer circumference.

The ignition system utilized within the UHEGT may be a simple high intensity spark ignition used in conventional gas turbines. In certain embodiments, the ignition system is used primarily during the startup process. In such embodiments, the ignition is normally turned off once the turbine engine is started. Once ignited, the combustion of the air/fuel mixture inside the combustion becomes self-sustaining and the ignition source is no longer required. Thus, for the start-up ignition, a spark ignition is used. Once the engine is ignited, no spark is needed. In certain embodiments, the ignition system is located within the stator system upstream of each turbine stator row. In other embodiments, the ignition system may be located at the leading edge of a first stator row. In further embodiments, the ignition system may be positioned within the hollow interior portion of the stators themselves.

The underlying principal behind the UHEGT technology is to establish complete combustion within a very small combustion volume and length. The volume is dictated by the stator blade height and the axial extension. The blade height may depend on the power size of the gas turbine. In certain embodiments, the blade may have a height of about 10 mm or greater. In other embodiments, the blade may have a height of about 60 cm or greater. The length of the blade may be based on an axial extension ranging from about 10% of the axial cord to about 50% of the axial chord. This is possible by keeping the fuel particles swirling and moving back and forth without immediately leaving the combustion zone. Two physical principles co-act to keep or prevent fuel particles from quickly leaving the combustion zone: (1) the generation of a system of vortices through different vortex generator configurations (vortical core of wake flows downstream of a cylindrical rod) and; (2) interaction of the system of vortices with surface curvature (the so called Coanda effect). Several different configurations are disclosed herein.

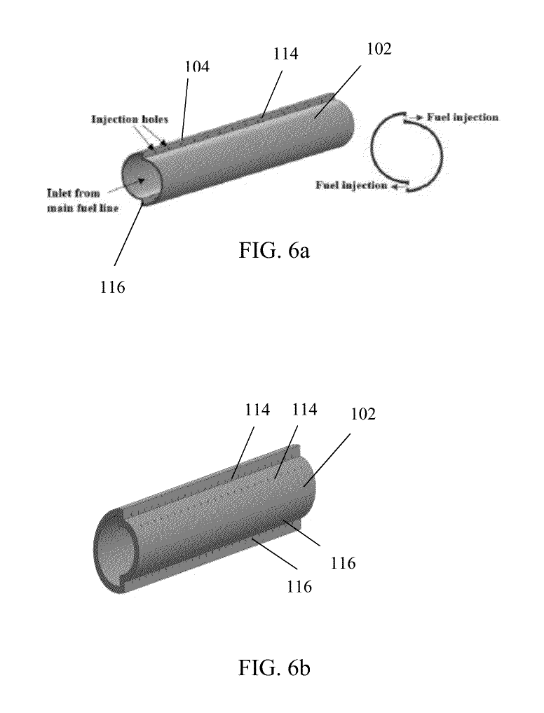

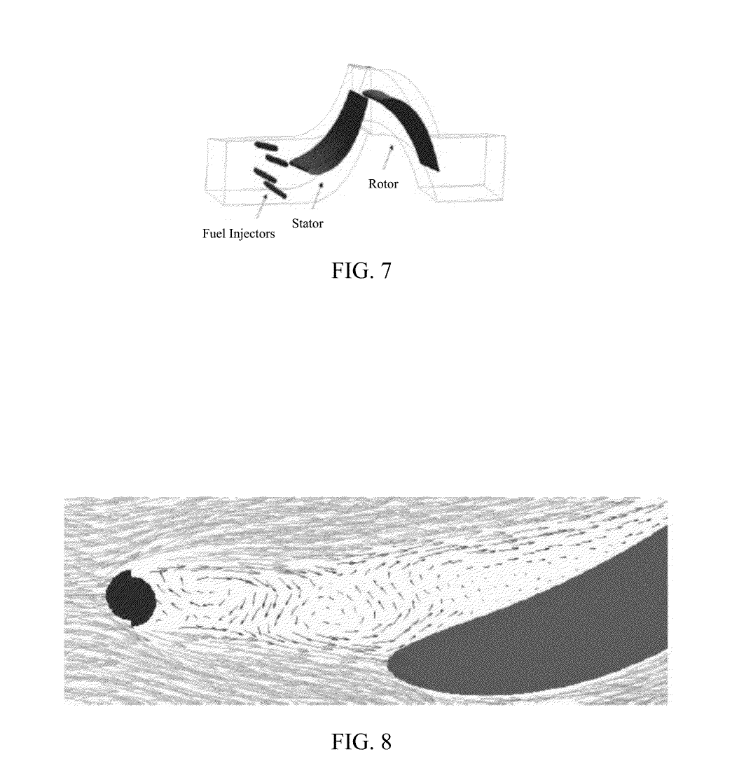

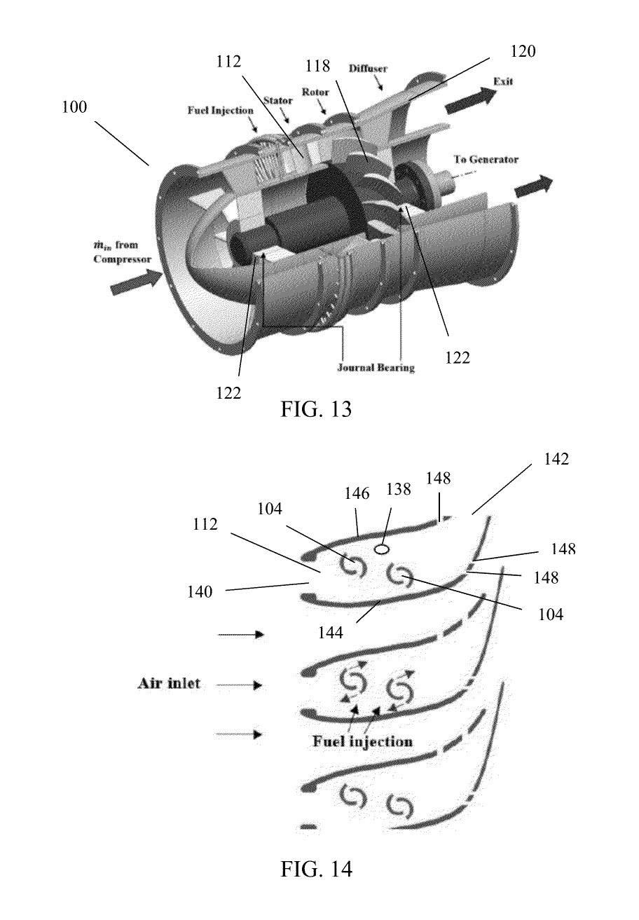

An inexpensive and relatively simple embodiment to manufacture which fulfills all of the criteria mentioned above for achieving an optimum designed fuel injector-stator unit or stator system is presented in FIGS. 6a and 6b. The embodiments illustrated within FIGS. 6a and 6b both generate vortex systems associated with Coanda effect while achieving an acceptable temperature non-uniformity. In this first embodiment, fuel is injected from cylindrical tubes (102) extended from hub (108) to shroud (106) (see FIGS. 12 and 13). Fuel enters the tube from the main fuel line (110) located on the casing and it is injected into the domain through small injection holes (104) on the top and bottom. The position of the injection holes (104) and their radii are varied to allow a prescribed temperature profile from hub to tip. Further details with respect to this first embodiment are set forth below with reference to FIGS. 12 and 13.

According to further embodiments, the plurality of cylindrical tubes (a.k.a., injector rods) may include two half cylinders with the same inner and outer diameters but with their cylinder center being offset. Offsetting the cylinder centers of the two half cylinders allows for the formation of a first fuel ejection surface (14) and a second fuel ejection surface (16) positioned opposite from each other along the cylindrical tube as illustrated within FIG. 6a. This configuration allows fuel to be ejected from the two fuel ejection surfaces into the combustion zone. In a further embodiment illustrated within FIG. 6b, the half cylinder configuration may include two half cylinders having the same cylindrical center but with a second half cylinder having a smaller inner and a smaller outer diameter. In both configurations, the first fuel ejection surface (14) and the second fuel ejection surface (16) may include a plurality of fuel injection holes allowing fuel to enter into a combustion zone within the stator system which is located upstream from the plurality of radially positioned stators.

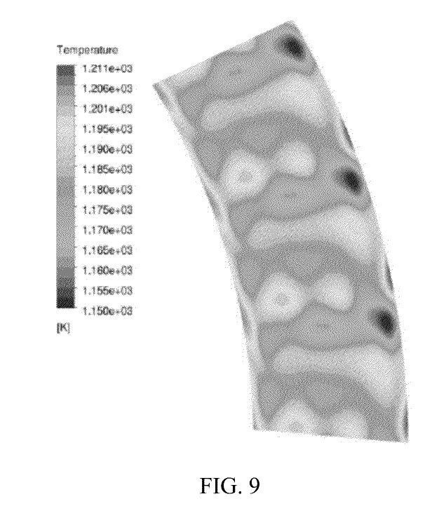

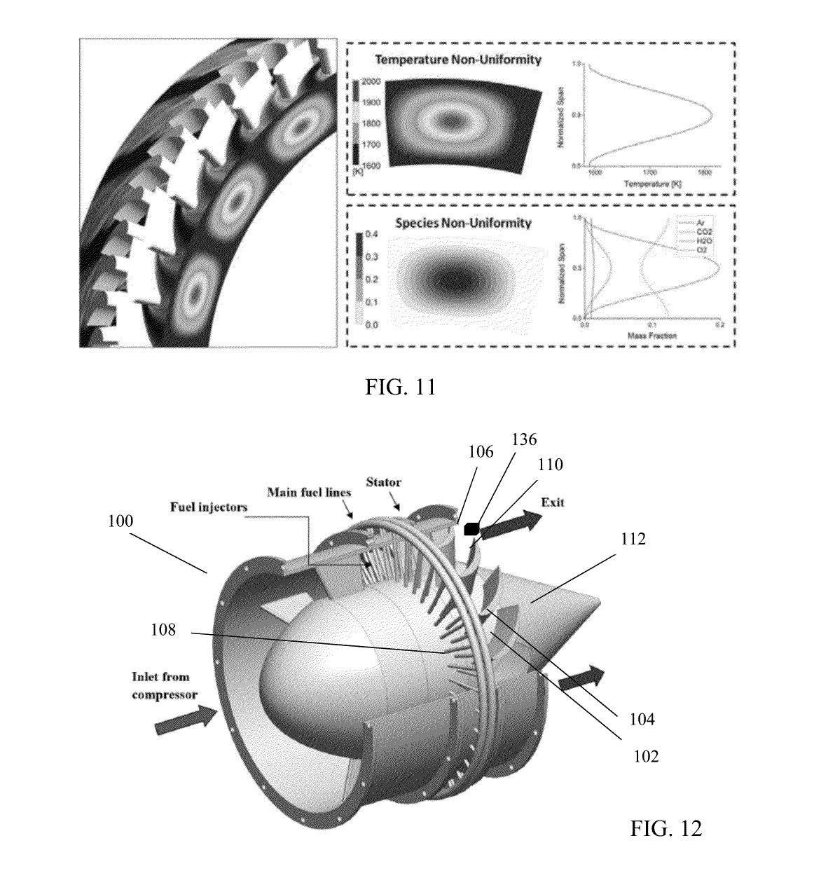

FIG. 8 shows the generation of vortex systems of small and large size to keep fuel particles within the combustion volume as long as possible by circulating the fuel particle back and forth. As illustrated within FIG. 8, the combination and interaction of the fuel injectors with the stator has brought about: the generation of system of vortices by the fuel injectors; the combination of Coanda effect (the tendency of a fluid jet to be attracted to a nearby surface) with von Karman vortices (a repeating pattern of swirling vortices around blunt bodies); elimination of the mixture zone, shown in FIG. 4 for a conventional combustor (the stator replaces the mixture zone in a conventional combustor); elimination of the secondary combustion zone (compare FIG. 4 showing a secondary combustion zone in a conventional combustor); elimination of additional mixing length (compare FIG. 4 showing additional mixing length in a conventional combustor); a fully uniform rotor exit temperature as illustrated in FIG. 9); a temperature non-uniformity at the stator exit of about 5.2% compared to about 22.5% in a conventional combustor (See FIG. 11). FIG. 8 shows the mechanism of fuel injection in conjunction with the von Karman Vortices and the Coanda effect.

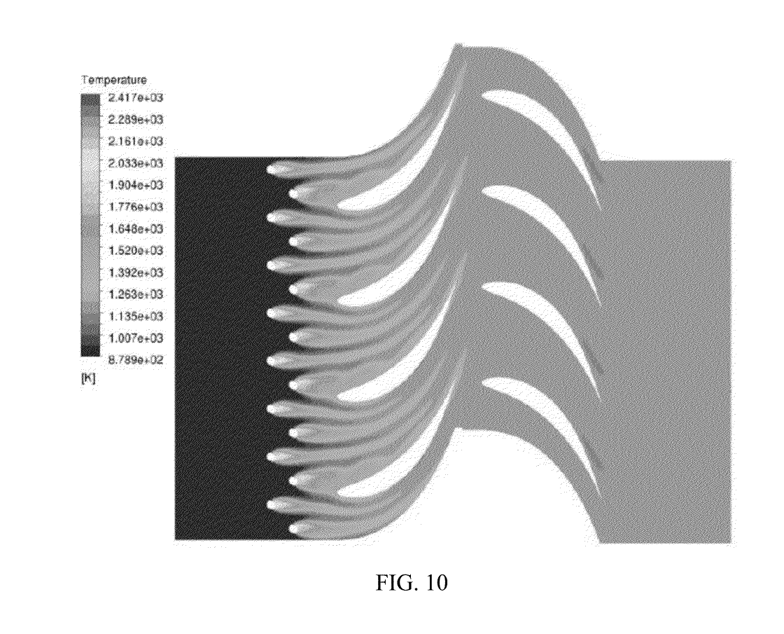

FIGS. 10 and 11 compare the temperature non-uniformities of UHEGT-injectors and a conventional gas turbine combustor. FIG. 10 illustrates the temperature distribution before the injectors, inside the stator and downstream of the stator and rotor. Temperature non-uniformity is calculated according to the formula NU=(Tₘₐₓ−Tₘᵢₙ)/T_{average}. FIG. 11 illustrates a conventional combustor having a temperature non-uniformity of 22.5%.

FIG. 12 is a sketch of a test section (100) of a designed prototype for an ultra high efficiency gas turbine. It shows the arrangement of the fuel injectors (104) followed by and interacting with the stator row (112). This figure illustrates the stator-internal combustion unit of an exemplary ultra-high efficiency gas turbine engine. High pressure air from the compressor enters the turbine unit and mixes with fuel that exits from the fuel injector cylindrical tubes. At start-up, a spark ignition system initiates the combustion process momentarily. A schematic representation of a spark ignition system (e.g., a spark plug) is illustrated within FIG. 12 as (136). In certain embodiments, the spark ignition system is positioned between the stator blades within the stator row. Once the flame is propagated circumferentially, the spark ignition stops and flame stability is sustained without spar. The test section (100) was used for a numerical simulation of the interaction between the fuel injectors and the stator blades. The results of the numerical simulation are shown in FIGS. 8, 9 and 10. The test section (100) will also be integrated into a combustion test facility that supplies air at required pressure and fuel air ratio. The test section will be fully instrumented for measuring the combustion stability, the temperature distribution before and after the fuel injector (upstream of the stator row) as well as downstream of the stator row. Cold air aerodynamic measurements will be conducted to determine the static and total pressure distributions from hub to tip from which the total pressure losses the three stations mentioned above will be calculated. The result of the experiments will be compared with the numerical simulation for calibrating the computational platform.

According to FIGS. 12 and 13, the fuel injection system includes a plurality of cylindrical tubes (102) which radially extend from the inner circumference of the turbine shroud (106) to the outer circumference of the turbine hub (108). The plurality of cylindrical tubes (102) have a first end and a second end. In certain embodiments, the first end may comprise a top end opening. The first end or top end opening of the cylindrical tubes (102) functions as an inlet and receives fuel from at least one main fuel line (110) which encircles the turbine hub (108). The second end of the plurality of cylindrical tubes (102) is attached at various positions along the circumference of the turbine hub (108). The cylindrical tubes (102) may have a first fuel ejection surface (114) and a second fuel ejection surface (116) opposite the first fuel ejection surface (114) (see FIG. 6). A plurality of fuel injection holes (104) may be positioned within the first fuel ejection surface (114) and the second fuel ejection surface (116) to allow fuel to enter into a combustion zone within the stator system. The combustion zone may be located upstream from the plurality of radially positioned stators (112) and may extend to encompass the area within which the stators (112) are positioned. In certain embodiments, the combustion zone extends to the leading edge of the stator system.

The ignition system of the first embodiment may consist of spark plugs inserted through an aperture within the casing or shroud of the turbine and which extend within the combustion zone within the interior of the gas turbine upstream from the stator system or stator row. In certain embodiments, the spark plugs may be positioned at the leading edge of the stator system or stator row.

In certain cases, the position of the fuel injection holes (104) and their angles along the first fuel ejection surface (114) and the second fuel ejection surface (116) may be varied and the fuel injection holes (104) may have radii which are varied. The varied position, angles and radii of the fuel injection holes (104) allow a prescribed temperature profile from the turbine hub to the tip of the of turbine stator blades (112). In certain embodiments, the plurality of stators (112) of the first embodiment may have an exit temperature non-uniformity value of about 5.2% and the rotor system may have a fully uniform exit temperature.

FIG. 13 is a cutout sketch of a designed single stage turbine test article showing additional components of the ultra-high efficiency gas turbine including the diffuser (120) and the journal bearing (122). This single stage turbine with stator-internal combustion followed by a rotor row was designed to perform computational simulations. The results of extensive computations are shown in FIGS. 8, 9 and 10. In particular, FIG. 13 shows the arrangement of the combustor interacting with a stator row (112) followed by a rotating turbine row (118). The test article (100) is designed to not exceed a power of 300 kW. The test article section is designed to be attached to an air supplier with a variable pressure ratio. In addition to the aero-thermodynamic measurements mentioned above, the torque and power of the test article will be measured by attaching a dynamometer and torque meter (details of such turbine measurements may be found at tpfl.tamu.edu). The experimental results will be compared with the numerical simulations for calibrating the computational platform. For the test article, power will be within the range of about 300 kW using a torque meter with a maximum rotational speed ranging from zero to about 8000 rpm.

FIG. 14 illustrates a second embodiment of the ultra-high efficiency gas turbine wherein the fuel injector-stator unit is integrated within the stator blades (112) themselves. This embodiment utilizes a completely redesigned turbine stator blade as seen in FIG. 14 which includes fuel injectors (104) positioned within the stator blades (112). These types of stator blades (112) are developed for major power generation original equipment manufacturers (OEMs) and are characterized by their high efficiencies and robustness against incidence changes at off-design operation.

The stator blades (112) in the second embodiment of the UHEGT are hollow and are designed to house the internal combustion which takes place within the hollow blades. These hollow blades are open at the leading edge (140), allowing the compressor air to enter into the inner blade. In certain embodiments, at the leading edge, the blades have a sudden expansion that allows generating two pre-defined vortex systems. In further embodiments, the blades have slots (148) on the suction side (144) and the pressure side (146) of the hollow blades (112). These slots (148) are optimized to ensure that the blade material is not subjected to excessive thermal stresses. The stator blades (112) may also include a passageway (138) for a spark ignition system (e.g., a spark plug) to be housed within the interior of the stator blade (112) for igniting the air/fuel mixture.

The plurality of stators utilized in the second embodiment in addition to being hollow and having an open leading edge (140) may also have an open trailing edge (142). The open leading edge (140) of the plurality of stators (112) allows compressed air to enter into an interior portion of each stator blade and the open trailing edge (142) allows high pressure air to exit from the interior portion of each stator blade (112). Each stator blade comprises at least one fuel injection hole (104) allowing fuel to enter within the interior portion of each stator blade. The fuel injection hole(s) may be located at any position along the stator blades. In certain cases, fuel enters the fuel injection holes within the plurality of stators through a plurality of fuel injectors comprising a plurality of cylindrical tubes (not shown). The plurality of cylindrical tubes have a first end opening and a second end opening. The first end opening functions as an inlet and receives fuel from at least one main fuel line which encircles the turbine hub and/or shroud and the second end opening is attached to the fuel injector holes (104) on the plurality of stators (112).

An ignition system may be positioned within the interior of the stator blades allowing combustion to occur within the hollow interior of the plurality of the stators. The ignition system may consist of spark plugs (not shown) inserted through an aperture within the casing or shroud of the turbine and/or which extend through at least one aperture or passageway (138) positioned within the stator blades, allowing the tips of the spark plugs to extend within the interior portion of the stator blades. In certain embodiments, the spark plugs are inserted through at least one aperture or passageway within the top portion of the stator blades. In other embodiments, the spark plugs are inserted through at least one aperture or passageway within the side portions of the stator blades.

In certain embodiments, each stator blade within the second embodiment has a first fuel injector hole (104) and a second fuel injector hole (104). The first and second fuel injector holes (104) may be positioned along a side surface of the stator blades. The second fuel injector hole may be positioned downstream from the first fuel injector hole on the stator blade and the second fuel injector hole may be offset at a lower position from the first fuel injector hole on the stator blade. The positioning of the first and second fuel injector holes allow for a substantially uniform temperature distribution resulting from combustion which takes place within each stator blade.

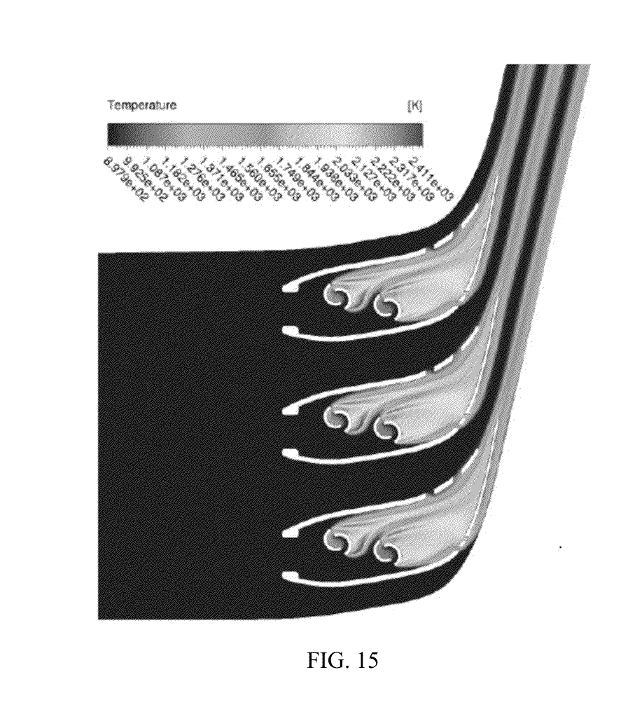

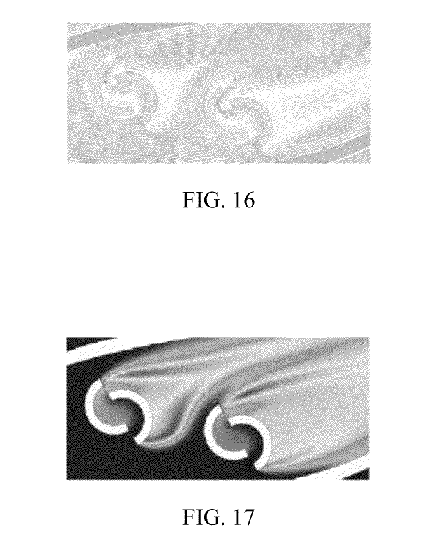

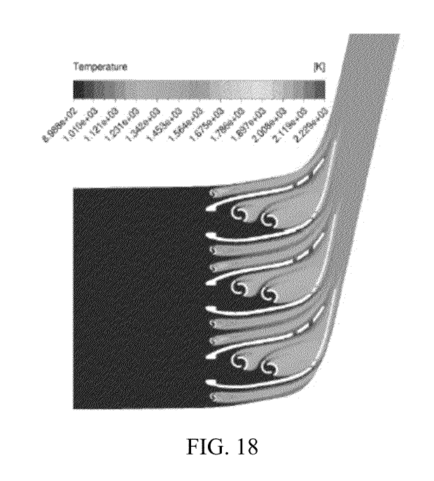

Thus, according to the embodiment illustrated within FIG. 14, the stator blades are designed to house the fuel injectors which are positioned inside the stator blades. The fuel injectors may extend from the main fuel line (e.g., at least one fuel line which encircles the shroud or casing of the turbine) through a conduit into the fuel injector holes within the stator blades. In certain embodiments, the conduit may be a cylindrical tube. Accordingly, in certain embodiments, a first fuel injector comprising a cylindrical tube extends from the main fuel line to the first fuel injector hole and a second fuel injector comprising a cylindrical tube extends from the main fuel line to the second fuel injector hole. FIGS. 16 and 17 show the velocity vectors and temperature distribution around the injectors. The area inside the blade is designed to provide sufficient space to allow for mixing between fuel and air particles. While a very defined combustion takes place inside each blade, temperature distribution (see FIG. 15) at the blade exit is not as uniform as in the first embodiment described above. To allow for a substantially uniform temperature distribution, between each two blades within the stator system, two fuel injectors are placed inside each blade as shown within FIG. 18 (note that this embodiment substantially improves the temperature uniformity at the stator exit). This fuel injector configuration produces a substantially uniform temperature distribution. In addition, the fuel injector-stator unit or stator system of the second embodiment has a cold layer along the suction and pressure surface inside and outside of the stator blades which ensures that the blade material is not exposed to adverse thermal stresses (this allows an increase of the turbine inlet temperature, which inherently increases turbine efficiency) as well as a substantially uniform temperature distribution at the exit of stator (inlet of the rotor) which ensures that the downstream rotor blade is not subjected to periodic temperature changes (it is common knowledge to those of skill in the art that one of the causes of rotor blade damage is temperature non-uniformity). In certain embodiments wherein the fuel injectors housed within the stator blades, the plurality of stators may have an exit temperature non-uniformity value of about 2.3%. In certain cases, this may be achieved by adding two additional fuel injectors between each pair of two adjacent stator blades.

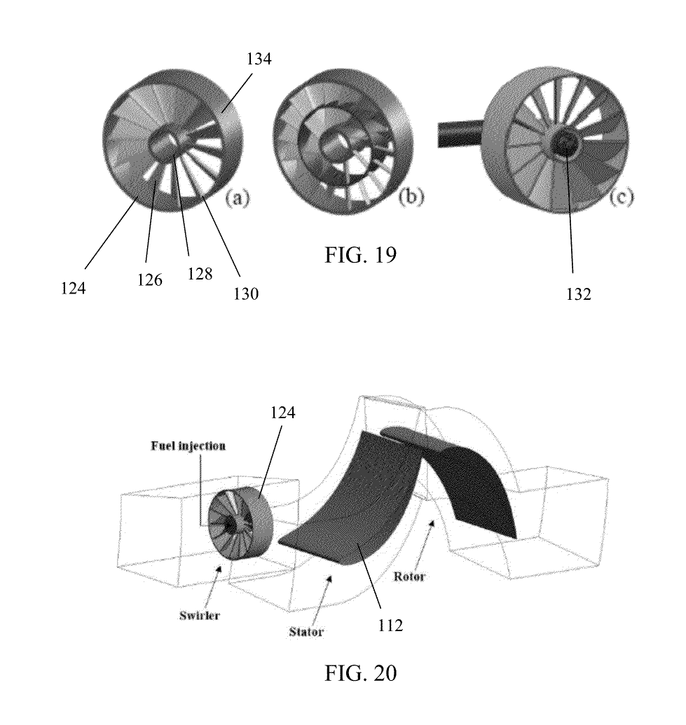

A third embodiment of the ultra-high efficiency gas turbine is illustrated within FIG. 19. In this embodiment, axial swirlers (124) are designed as shown in FIG. 19 for vortex generation. The vane profiles (126) on the axial swirlers are based on a Bezier curve having an inlet and exit angle of 90 and 45 degrees, respectively. In the single layer vortex generator shown in FIG. 19a, the vanes are scaled from hub (128) to tip (130) to maintain a constant cord-spacing ratio. The fuel is injected through a nozzle positioned within the center of the swirler (132). FIG. 19b shows a multilayer vortex generator which can be used to achieve different swirl values or numbers at different radial locations. The fuel is injected in the center of the vortex generator through a fuel injector as shown in FIG. 19c.

The ignition system of the third embodiment may consist of spark plugs inserted through an aperture within the casing or shroud of the turbine and/or which extend within the combustion zone within the stator system upstream from the stator row within the interior of the gas turbine. In certain embodiments, the spark plugs may be positioned at the leading edge of the stator system or stator row.

FIG. 20 shows the numerical domain for a third embodiment of the ultra-high efficiency gas turbine. Periodic boundary conditions are utilized in order to reduce the size of computational domain to include only one blade from each row. In this design, axial swirlers (124) are placed right before or in front of the stator blades injecting fuel and air into the space between the blades. In certain embodiments, the axial swirlers (124) are positioned in the middle of two adjacent stator blades to minimize direct interaction between the combustion flame and the stator blades.

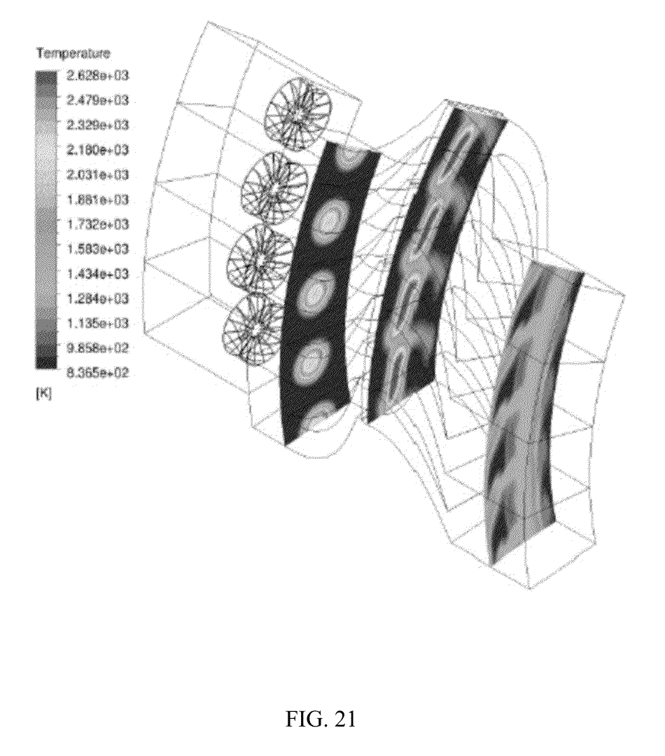

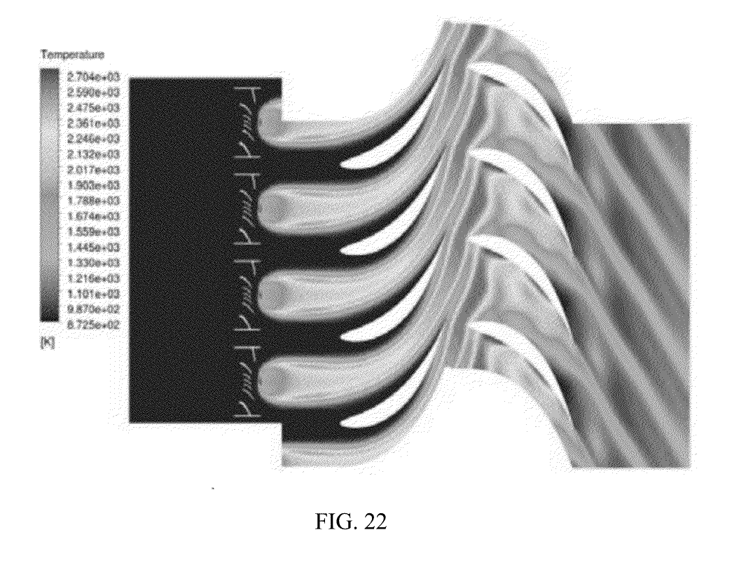

FIG. 21 shows the temperature distribution before and after the stator and rotor blades and the temperature distribution at rotor inlet, respectively. As shown within FIG. 21, at the rotor inlet, there is a cold flow near the end walls and a hot core in the middle. There is also a lower temperature near hub and shroud which can be a positive factor because it protects the end walls from the hot flame radiation. Temperature non-uniformity is around 17% which is still much lower than 22.5% for a conventional gas turbine. FIG. 22 shows the temperature distribution at 60% of span. As shown in this figure, temperature rises along the stator and the early stages of rotor blade due to fuel burning.

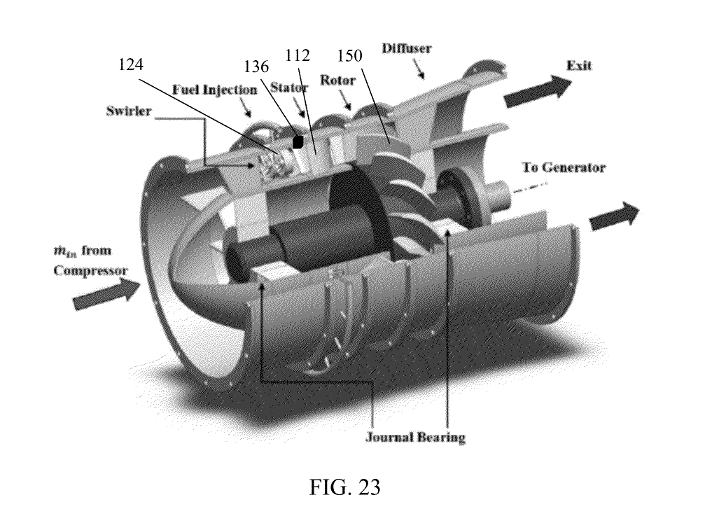

A schematic of a single stage turbine of the third embodiment having an axial swirl generator is shown in FIG. 23. As illustrated within FIG. 23, a plurality of axial swirlers (124) may be positioned radially around a substantially cylindrical hub upstream from a plurality of stators (112) within the stator system. The turbine shroud encircles the plurality of axial swirlers (124). The plurality of axial swirlers (124) may include at least one inner hub (128), an outer hub (128) and vanes (126) positioned between the inner (128) and outer hub (134). The vanes (126) may have an inlet angle of 90 degrees and an exit angle of 45 degrees. The fuel injection system within the third embodiment may include a plurality of cylindrical tubes (102) having a first end opening and a second end opening. The first end opening may functions as an inlet, receiving fuel from at least one main fuel line (110) which encircles the turbine hub (108). The second end opening may be attached to the inner hub (128) of the plurality of axial swirlers (124) to allow fuel to be injected for combustion within the stator system. Combustion is initiated by an ignition system schematically illustrated by reference number (136) positioned upstream from or at the leading edge of the stator blades or stator row. Also illustrated within FIG. 23 is a plurality of rotors (150) downstream from the stator row.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A stator-internal combustion system for an ultra-high efficiency gas turbine engine comprising a fuel injection system, an ignition system, a stator system, and a rotor system,
wherein the stator system comprises a plurality of stators positioned radially around a central axis and wherein the stator system has a leading edge and a trailing edge,
wherein the fuel injection system injects fuel within the stator system through at least one of the following mechanisms: a) a plurality of conduits which inject fuel at the leading edge of the stator system and b) a plurality of conduits which inject fuel within the stators themselves;
wherein the ignition system is located within the stator system,
wherein the rotor system comprises a plurality of rotors positioned radially around the central axis downstream from the stator system; and,
wherein the stator-internal combustion system does not require the use of a gas turbine combustor.

2. The stator-internal combustion system of claim 1, wherein the plurality of stators are positioned radially around a substantially cylindrical turbine hub, wherein a turbine shroud encircles the plurality of stators which extend from the turbine hub, wherein the turbine shroud has an inner circumference and wherein the turbine hub has an outer circumference.

3. The stator-internal combustion system of claim 2, wherein the fuel injection system injects fuel within the stator system through a plurality of conduits which inject fuel at the leading edge of the stator system and wherein the fuel injection system comprises a plurality of conduits which radially extend from the inner circumference of the turbine shroud to the outer circumference of the turbine hub.

4. The stator-internal combustion system of claim 3, wherein the plurality of conduits comprise a plurality of cylindrical tubes having a first end opening and a second end, wherein the first end opening functions as an inlet and receives fuel from at least one main fuel line which encircles the turbine hub and the second end is attached at various positions along the circumference of the turbine hub.

5. The stator-internal combustion system of claim 4, wherein the plurality of cylindrical tubes comprise a first fuel ejection surface and a second fuel ejection surface opposite the first flange, wherein the first fuel ejection surface and the second fuel ejection surface comprise a plurality of fuel injection holes allowing fuel to enter into a combustion zone within the stator system which is located upstream from the plurality of radially positioned stators.

6. The stator-internal combustion system of claim 5, wherein the position of the fuel injection holes and their angles along the first fuel ejection surface and the second fuel ejection surface are varied and wherein the fuel injection holes have radii which are varied, wherein the varied position and radii of the fuel injection holes allow a prescribed temperature profile from the turbine hub to the tip of the stator blades.

7. The stator-internal combustion system of claim 6, wherein combustion within the stator system results in the plurality of stators having an exit temperature non-uniformity value of about 5.2%.

8. The stator-internal combustion system of claim 7, wherein combustion within the stator system results in the rotor system having a fully uniform exit temperature.

9. The stator-internal combustion system of claim 2, wherein the fuel injection system injects fuel within the stator system through a plurality of conduits which inject fuel within the stators themselves and wherein the plurality of stators comprise a hollow body defining an open leading edge, an open trailing edge and a pressure surface and a suction surface extending between said leading and trailing edges.

10. The stator-internal combustion system of claim 9, wherein the open leading edge of the plurality of stators allows compressed air to enter into an interior portion of each stator blade and the open trailing edge allows high pressure air to exit from the interior portion of each stator blade.

11. The stator-internal combustion system of claim 10, wherein each stator blade comprises at least one fuel injection hole allowing fuel to enter within the interior portion of each stator blade.

12. The stator-internal combustion system of claim 11, wherein fuel enters the fuel injection holes within the plurality of stators through a plurality of fuel injectors comprising a plurality of cylindrical tubes having a first end opening and a second end opening, wherein the first end opening functions as an inlet and receives fuel from at least one main fuel line which encircles the turbine hub and the second end opening is attached to the fuel injector holes on the plurality of stators.

13. The stator-internal combustion system of claim 12, wherein the ignition system is positioned within the interior of the stator blades allowing combustion to occur within the hollow interior of the plurality of the stators.

14. The stator-internal combustion system of claim 13, wherein the leading edge of the plurality of stator blades are expanded to allow for the generation of two pre-defined vortex systems.

15. The stator-internal combustion system of claim 14, wherein the hollow stator blades have a suction and a pressure side within the interior of the stator blades and wherein the suction and pressure sides within the interior of the stator blades have slots which are optimized to ensure that the stator blades are not subjected to excessive thermal stresses.

16. The stator-internal combustion system of claim 15, wherein each stator blade comprises a first fuel injector hole and a second fuel injector hole, wherein the second fuel injector hole is positioned downstream from the first fuel injector hole on the stator blade and wherein the second fuel injector hole is offset at a lower position from the first fuel injector hole on the stator blade, wherein a first fuel injector extends from the main fuel line to the first fuel injector hole and a second fuel injector extends from the main fuel line to the second fuel injector hole.

17. The stator-internal combustion system of claim 2, wherein the fuel injection system injects fuel within the stator system through a plurality of conduits which inject fuel at the leading edge of the stator system and wherein a plurality of axial swirlers are positioned radially around the substantially cylindrical hub upstream from the plurality of stators within the stator system, wherein the turbine shroud encircles the plurality of axial swirlers and wherein the plurality of axial swirlers comprise at least one inner hub, an outer hub and vanes positioned between the inner and outer hub.

18. The stator-internal combustion system of claim 17, wherein the vanes have an inlet angle of 90 degrees and an exit angle of 45 degrees.

19. The stator-internal combustion system of claim 18, wherein the fuel injection system comprises a plurality of cylindrical tubes having a first end opening and a second end opening, wherein the first end opening functions as an inlet and receives fuel from at least one main fuel line which encircles the turbine hub and the second end opening is attached to the inner hub of the plurality of axial swirlers to allow fuel to be injected for combustion within the stator system.

20. A method for operating an ultra-high efficiency gas turbine engine comprising:
supplying fuel from a main fuel line which encircles a substantially cylindrical turbine hub to a plurality of cylindrical tubes which radially extend from the main fuel line to the turbine hub upstream from a plurality of stators radially extending from the turbine hub within a stator system;
injecting fuel from the plurality of cylindrical tubes from a plurality of fuel injection holes positioned along the cylindrical tubes into a combustion zone within the stator system;
allowing compressed air generated by a compressor upstream from the stator system to enter the stator system to create an air/fuel mixture within the stator system;
igniting the air/fuel mixture through an ignition system positioned within the stator system at startup;
generating a high pressure combustion gas flow through combustion of the air/fuel mixture within the stator system which passes through the plurality of stators within the stator system towards a plurality of rotors positioned downstream from the plurality of stators, wherein the plurality of rotors radially extend from the turbine hub;
allowing the high pressure combustion gas to rotate the plurality of rotors about a central axis within the turbine to generate power,
wherein combustion within the stator system results in the plurality of stators having an exit temperature non-uniformity value of about 5.2%.
